(19) United States
(12) Patent Application Publication
(10) Pub. No.: US 2026/0241762 A1
(43) Pub. Date: Aug. 20, 2026

(54) TOP MOUNT FOR VEHICLE SUSPENSION AND MANUFACTURING METHOD OF THEREOF

(71) Applicant: HYUNDAI POLYTECH, Chungcheongbuk-do (KR)

(72) Inventors: Jaecheon CHO, Daegu (KR); Chunsung PARK, Chungcheongbuk-do (KR)

(73) Assignee: HYUNDAI POLYTECH, Chungcheongbuk-do (KR)

(21) Appl. No.: 19/154,757

(22) PCT Filed: Nov. 14, 2024
(86) PCT No.: PCT/KR2024/017984

§ 371 Date: Aug. 7, 2025

(30) Foreign Application Priority Data
Nov. 29, 2023 (KR) 10-2023-0169532

(51) Int. Cl. B60G 15/06

(52) U.S. Cl. CPC B60G 15/067; B60G 2204/41; B60G 2204/43; B60G 2206/7101; B60G 2206/81012

(57) ABSTRACT

The disclosed top mount for vehicle suspension includes a bracket that is coupled to a vehicle body and has a receiving hole therein; a bush disposed in the receiving hole, an upper cap provided on the bracket to be seated on an upper side of the receiving hole and to support an upper surface of the bush and a lower cup that is inserted into the lower side of the receiving hole and coupled to the bracket to support the lower surface of the bush, and the bracket and the upper cap are integrally formed of plastic.

### DESCRIPTION

### Technical Field

The present disclosure relates to a top mount for vehicle suspension and a manufacturing method thereof. More particularly, it pertains to a lightweight top mount and its manufacturing method for vehicle suspension.

### Background Art

This invention resulted from research conducted under the 2023 Chungbuk Components & Equipment Technology Development Support Project—“Development of Lightweight Insulator with First Application of Laser Welding”—funded by Chungcheongbuk-do and the Chungbuk Institute of Science and Technology Innovation.

A vehicle suspension device absorbs vibration and impact energy transferred from the road, provided between the vehicle body and axle. A typical suspension system includes a shock absorber and a coil spring installed around the shock absorber.

The coil spring attenuates road shocks, while the shock absorber suppresses the spring's free vibration, complementarily reducing the transmitted vibration.

The shock absorber comprises a cylinder fixed to the wheel side, a piston sliding within the cylinder, and a piston rod connected at one end to the piston and extending out of the cylinder, fixed to the vehicle body. During travel, the piston reciprocates (compression and rebound) to dampen vibration and impact.

In this system, a top mount secures the suspension to the vehicle body. It includes a bushing that attaches to the piston rod end and fits into a bracket that anchors to the body.

The bushing's elastic deformation mitigates vibration transmission from the piston rod to the body.

Previously, top mount components-particularly the bracket-were predominantly metal. However, to reduce weight and improve fuel economy, efforts have intensified to use alternative materials for top mounts.

### DISCLOSURE

### Technical Problem

The present embodiment provides a lightweight top mount for vehicle suspension and a method for manufacturing the same.

The present embodiment provides a top mount for vehicle suspension, wherein durability is maintained, supplemented, and improved, and a method for manufacturing the same.

The present embodiment provides a top mount for vehicle suspension, wherein the number of components is reduced and productivity is enhanced, and a method for manufacturing the same.

The present embodiment provides a top mount for vehicle suspension with improved assemblability, and a method for manufacturing the same.

The present embodiment provides a top mount for vehicle suspension that improves vehicle fuel efficiency as well as economic efficiency and marketability, and a method for manufacturing the same.

### Technical Solution

According to one aspect of the present invention, a bracket coupled to a vehicle body and having a receiving hole therein; a bush disposed in the receiving hole; an upper cap seated on an upper side of the receiving hole and provided on the bracket to support an upper surface of the bush; and a lower cup inserted into a lower side of the receiving hole and coupled to the bracket to support a lower surface of the bush; are included, wherein the bracket and the upper cap are integrally formed of plastic.

The bracket and the upper cap may be formed of a plastic comprising a mixture of nylon-based plastic and glass fiber-reinforced plastic.

The bracket may include a main body portion having the receiving hole formed therein and flange portions obliquely extending from both sides of the main body portion.

The main body portion may include a plurality of first protrusions protruding outwardly from an outer circumferential surface and extending vertically, the plurality of first protrusions being spaced apart along the outer circumferential surface.

The upper cap may include a plurality of second protrusions protruding upward from a top surface, extending radially from an opening formed at the center, and arranged spaced apart around the opening.

The flange portion may include a plurality of third protrusions protruding downward from a bottom surface, extending along a longitudinal direction of the flange portion, and arranged spaced apart along an outer circumferential surface of the main body portion contacting the flange portion.

The first protrusions may extend from around the upper cap to a lower side of the main body portion, and portions where the main body portion and the flange portion meet may also extend to portions in contact with the flange portion.

The lower cup may include an insertion portion having an outer circumferential surface inserted into the lower side of the receiving hole; and a stepped portion protruding from a lower end of the insertion portion to support a lower end of the bracket.

The bush may include an inner pipe fixed to an upper end of a piston rod and positioned at a center of the receiving hole; an outer pipe press-fitted into the receiving hole of the bracket; and a vibration-damping rubber interposed between the inner pipe and the outer pipe.

The flange portion may include a bolt coupling hole obliquely formed therethrough.

The top mount may further include a washer coupled to one side of the bolt coupling hole.

According to another aspect of the present invention, a method for manufacturing a top mount for vehicle suspension is provided, comprising integrally forming, of plastic, a bracket coupled to a vehicle body and having a receiving hole therein, and an upper cap seated on an upper side of the receiving hole and provided on the bracket; inserting a bush into a lower side of the receiving hole so that the bush is disposed inside the receiving hole; inserting a lower cup from the lower side to the upper side of the receiving hole such that the lower cup supports a lower surface of the bush and is coupled to the bracket; and welding the bracket and the lower cup to couple them together.

The lower cup may include an insertion portion having an outer circumferential surface inserted into the lower side of the receiving hole; and a stepped portion protruding from a lower end of the insertion portion to support a lower end of the bracket, wherein the lower cup is inserted from the lower side to the upper side of the receiving hole such that the lower end of the bracket is seated and supported by the stepped portion, and wherein the bracket and the insertion portion are welded and coupled together.

The bracket and the upper cap may be injection-molded.

### Advangateous Effects

The present embodiment provides a lightweight top mount for vehicle suspension and a method for manufacturing the same.

The present embodiment provides a top mount for vehicle suspension and a method for manufacturing the same, in which durability is maintained, improved, or enhanced.

The present embodiment provides a top mount for vehicle suspension and a method for manufacturing the same, in which the number of components is reduced and productivity is improved.

The present embodiment provides a top mount for vehicle suspension and a method for manufacturing the same, in which assembly efficiency is improved.

The present embodiment provides a top mount for vehicle suspension and a method for manufacturing the same, in which fuel efficiency of the vehicle is improved and economic efficiency and marketability are enhanced.

### DESCRIPTION OF DRAWINGS

FIG. 1 is a perspective view illustrating a top view of a top mount for vehicle suspension according to an embodiment of the present invention.

FIG. 2 is a perspective view illustrating a bottom view of a top mount for vehicle suspension according to an embodiment of the present invention.

FIG. 3 is a perspective view illustrating a top view of a top mount for vehicle suspension according to an embodiment of the present invention, with a portion cut away.

FIG. 4 is a cross-sectional view showing a state in which the top mount for vehicle suspension according to an embodiment of the present invention is assembled.

FIG. 5 is a perspective view showing a state before assembly of the top mount for a vehicle suspension according to an embodiment of the present invention.

### MODE FOR INVENTION

Hereinafter, the present embodiment will be described in detail with reference to the accompanying drawings. The following embodiment is presented to sufficiently convey the spirit of the present invention to those having ordinary skill in the art to which the present invention pertains. The present invention is not limited to the embodiment presented herein, and may be embodied in other forms. In the drawings, portions unrelated to the description may be omitted to clarify the invention, and the sizes of components may be exaggerated to aid understanding.

A suspension of vehicle, in which a top mount (10) for vehicle suspension is employed, is to attenuate vibration and shock transmitted from the road surface to the vehicle body, and includes a shock absorber (not shown), and a coil spring (not shown) installed around the shock absorber (not shown).

The shock absorber (not shown) includes a cylinder fixed to the wheel side, a piston slidably received in the cylinder, and a piston rod, one end of which is connected to the piston and the other end of which extends to the outside of the cylinder and is fixed to the vehicle body.

Accordingly, the shock absorber (not shown) attenuates vibration and shock transmitted from the road surface to the vehicle body by repeating a compression stroke and a rebound stroke according to the reciprocating motion of the piston sliding relative to the cylinder during driving of the vehicle.

The coil spring (not shown) is installed around the shock absorber (not shown) to elastically support the distance between the cylinder and the piston rod in a direction away from each other, thereby enhancing the vibration damping effect of the shock absorber (not shown).

Such a suspension has its lower side fixed to the wheel side and its upper side mounted to the vehicle body via the top mount. That is, the top mount allows the piston rod of the shock absorber (not shown) to be mounted to the vehicle body while attenuating the vibration transmitted from the piston rod to the vehicle body.

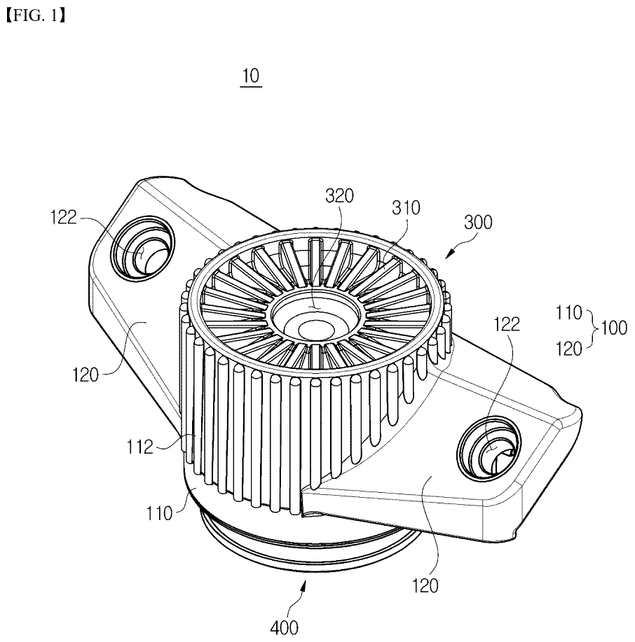

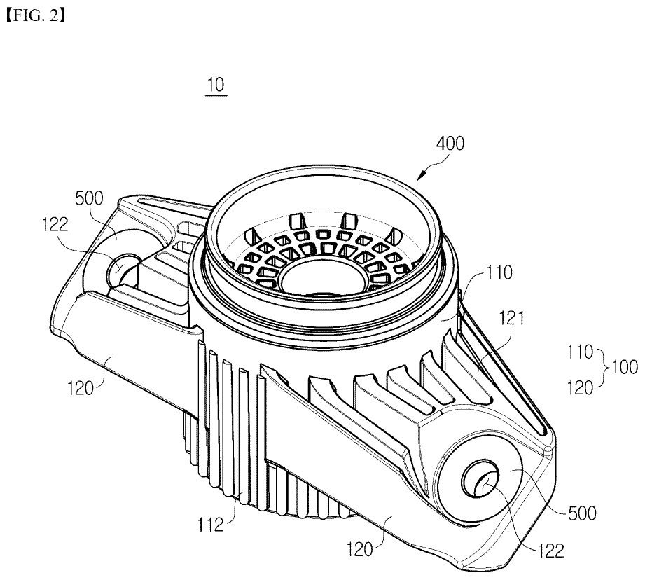

FIG. 1 is a perspective view looking from above at a top mount (10) for a suspension according to an embodiment of the present invention, and FIG. 2 is a perspective view looking from below at the top mount (10) for a suspension according to the embodiment of the present invention.

Referring to FIGS. 1 and 2, the top mount (10) for a vehicle suspension according to the embodiment of the present invention includes a bracket (100), an upper cap (300), a lower cup (400), and a washer (500).

The bracket (100) forms the outer framework of the top mount and is a component that is coupled to the vehicle body.

A conventional bracket (100), for example, is generally made of a metal material such as aluminum. This provides an advantage in securing high rigidity of the bracket (100), but increases weight, leading to reduced fuel efficiency of the vehicle.

Therefore, the bracket (100) according to the embodiment of the present invention is made of a plastic material rather than metal, thereby achieving weight reduction of the top mount and further improving vehicle fuel efficiency through vehicle weight reduction, while maintaining and complementing durability by improving the shape of the bracket (100) itself.

The bracket (100) includes a main body portion (110) located at the center, and a flange portion (120) extending laterally from the main body portion (110), and both the main body portion (110) and the flange portion (120) are made of plastic.

The main body portion (110) has a cylindrical shape, a receiving hole (111) is formed therein, and it may include a first projection (112) formed protruding outward from the outer circumferential surface.

The receiving hole (111) receives a bush (200), which will be described in detail later.

A plurality of first projections (112) are provided, each extending in the vertical direction and spaced along the outer circumferential surface.

The first projection (112) may extend up to the contact area between the main body portion (110) and the flange portion (120), which will be described later. In other words, as shown in FIG. 1, when the lateral outer circumferential surface of the main body portion (110) contacts the inclined flange portion (120), the first projection (112) extends toward the lower side of the main body portion (110) around the upper cap (300) and is formed to gradually shorten in vertical length up to the contact portion between the main body portion (110) and the flange portion.

Thus, the bracket (100) can increase the rigidity of the bracket (100) against vertical external forces applied by the vertically moving shock absorber (not shown) by providing the first projection (112) on the main body portion (110).

The flange portion (120) is formed to extend obliquely to both sides of the main body, and may include a bolt connection hole (122) formed at the outer edge and a third projection (121) formed protruding downward on the lower surface.

The bolt connection hole (122) may be formed to pass through obliquely at the outer edge of the flange portion (120). Thus, the bracket (100) may be fixed to the vehicle body by mounting a fastening bolt in the bolt connection hole (122).

A plurality of third projections (121) are provided, each extending in the longitudinal direction of the flange portion (120) and spaced along the outer circumferential surface of the main body portion (110) in contact with the flange portion (120).

As shown in FIG. 2, the third projection (121) may extend from the outer circumferential surface of the main body portion (110) to the portion where the bolt connection hole (122) is formed or a recessed point around the bolt connection hole (122), and may have different horizontal lengths.

Thus, the bracket (100) can increase its rigidity against horizontal external forces applied by the vertically moving shock absorber (not shown) by providing the third projection (121) on the main body portion (110).

The upper cap (300) is mounted on the upper side of the receiving hole (111) to support the upper surface of the bush (200), and is provided on the bracket (100). The upper cap (300) is made of plastic, like the bracket (100).

The upper cap (300) may include an opening (320) at its center and a second projection (310) protruding upward from the top surface.

A plurality of second projections (310) are provided, each extending radially from the opening (320) and spaced around the circumference of the opening (320).

As shown in FIG. 1, the second projection (310) may be formed inclined such that the height is lower near the opening (320) and higher farther from the opening (320).

Thus, the upper cap (300) can increase its rigidity against horizontal external forces applied by the vertically moving shock absorber (not shown) by providing the second projection (310).

The upper cap (300) is integrally formed with the bracket (100). Generally, in conventional designs, the upper cap (300) is made of metal and is provided as a separate component from the bracket (100), requiring an assembly process with the bracket (100). In the embodiment of the present invention, the upper cap (300) and bracket (100) are both made of plastic and are integrally formed, thereby reducing the weight of the top mount and reducing the assembly process.

The bracket (100) and the upper cap (300) may be made of a plastic material that is a mixture of nylon-based plastic and glass fiber-reinforced plastic. For example, the bracket (100) may be made of a plastic in which PA66 and GF50 are mixed. However, the plastic of the bracket (100) and the upper cap (300) of the present invention is not limited to this, and as long as it is a lighter material than metal, it may include various plastics other than nylon-based plastic and glass fiber-reinforced plastic mixed in various mixing ratios.

The lower cup (400) is a component that is inserted into the lower side of the receiving hole (111) to support the lower surface of the bush (200), and is coupled with the bracket (100).

The lower cup (400) is formed in a hollow cylindrical shape. Specifically, the lower cup (400) has cup openings formed on its top and bottom surfaces, wherein the cup opening on the top surface is formed with a smaller diameter than the cup opening on the bottom surface, and a plurality of recessed holes may be formed on the top surface toward the lower side. The side of the lower cup (400) includes an insertion portion (410) and a step portion (420), and may be arranged such that at least a portion of it closely contacts the inner circumferential surface of the receiving hole (111). The insertion portion (410) and step portion (420) will be described in detail later.

The washer (500) is coupled to one side of the bolt connection hole (122), and when a fastening bolt is engaged with the bolt connection hole (122), it increases the surface area to which force is applied, thereby dispersing pressure and improving the durability of the flange portion (120). The washer (500) may be made of a metal material, and, for example, may be made of aluminum.

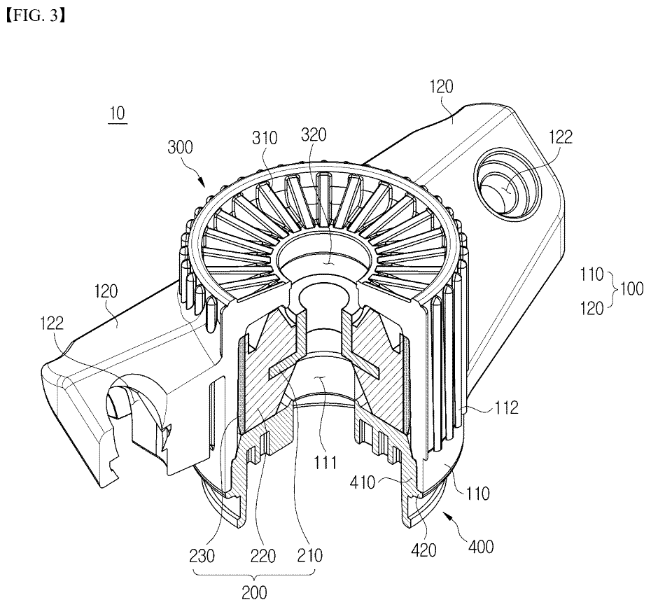

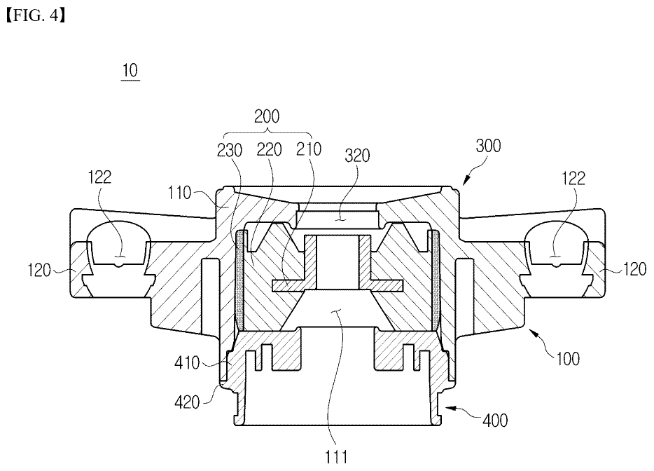

FIG. 3 is a perspective view showing a partial cutaway of the top mount (10) for a vehicle suspension according to an embodiment of the present invention as viewed from above, and FIG. 4 is a cross-sectional view showing the top mount (10) for a vehicle suspension according to the embodiment of the present invention in an assembled state.

Referring to FIGS. 3 and 4, the top mount (10) for a vehicle suspension according to the embodiment of the present invention includes a bush (200).

The bush (200) is disposed inside the receiving hole (111) formed in the bracket (100), and is configured to elastically support the end of the piston rod of the shock absorber (not shown). It includes an inner pipe (210), an outer pipe (230), and a vibration-insulating rubber (220).

The inner pipe (210) is positioned at the center of the receiving hole (111) and is fixedly installed on the upper end of the piston rod. The inner pipe (210) is formed in a hollow cylindrical shape with a through-hole formed at the center to allow the piston rod of the shock absorber (not shown) to be inserted through. The lower end of the pipe may include a flat portion to be fixed to the vibration-insulating rubber (220), and may thus have an inverted “T” shape. The inner pipe (210) may be made of cold heading carbon steel, which is a metallic material.

The outer pipe (230) is formed in a hollow cylindrical shape and is press-fitted and inserted into the receiving hole (111) of the bracket (100). The outer pipe (230) may be made of plastic. For example, the outer pipe (230) may be made of a plastic in which PA66 and GF35 are mixed. However, the outer pipe (230) of the present invention is not limited thereto, and may include various plastics mixed in various ratios, as long as they are lighter than metal, including but not limited to nylon-based plastic and glass fiber-reinforced plastic.

The vibration-insulating rubber (220) is interposed between the inner pipe (210) and the outer pipe (230). The vibration-insulating rubber (220) is formed in a hollow cylindrical shape, and its upper surface may have a concave-convex shape with alternating recessed and raised parts along its circumference to enhance the shock-absorbing effect under compression in the vertical direction. The vibration-insulating rubber (220) may be made of rubber, and particularly, it may be made of natural rubber with strong elasticity, flexibility, and high tensile strength.

The lower cup (400) is provided with an insertion portion (410) and a step portion (420) on its side to couple with the bracket (100) that houses the bush (200).

The insertion portion (410) is inserted into the lower side of the receiving hole (111), and the step portion (420) is formed to protrude at the lower end of the insertion portion (410) to support the lower end of the bracket (100). At this time, the insertion portion (410) is formed to be relatively thicker than other parts of the lower cup (400), and the portion of the bracket (100) that contacts the insertion portion (410) may be formed thinner than other portions of the main body portion (110) of the bracket (100).

The lower cup (400) may be joined to the bracket (100) by welding. That is, the insertion portion (410) of the lower cup (400) may be joined to the bracket (100) by welding. A laser welding method using a laser may be applied, for example. By welding and coupling the lower cup (400) and the bracket (100) in this manner, the assemblability of the top mount can be improved.

Hereinafter, the manufacturing method of the top mount (10) for a vehicle suspension according to the embodiment will be described.

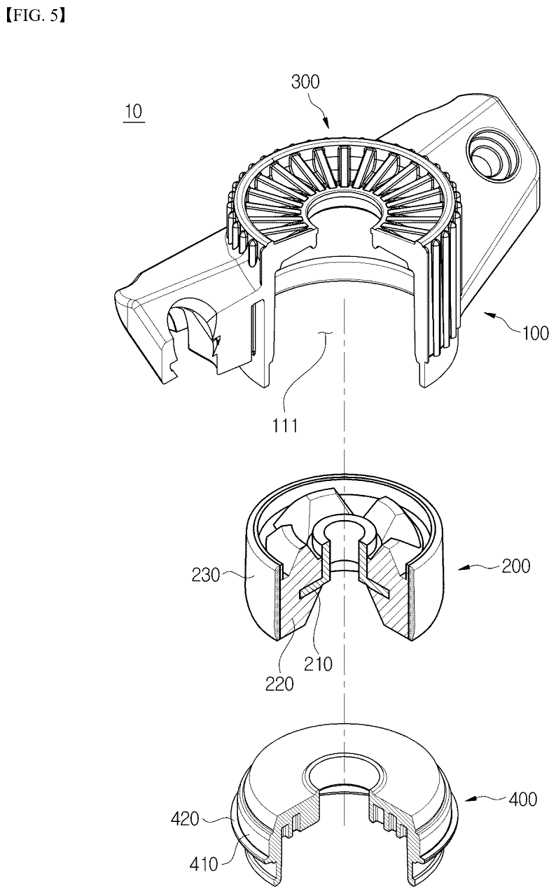

FIG. 5 is a perspective view showing the state before the top mount (10) for a vehicle suspension according to the embodiment of the present invention is assembled.

Referring to FIG. 5, according to an embodiment of the present invention, the bracket (100), which is made of plastic and integrally formed with the upper cap (300), the bush (200), and the lower cup (400) may be sequentially assembled and manufactured.

First, the bracket (100), which is coupled to the vehicle body and has the receiving hole (111) formed therein, and the upper cap (300), which is seated on the upper side of the receiving hole (111) and provided on the bracket (100), are integrally formed and made of plastic. The bracket (100) and the upper cap (300) may be manufactured by an injection molding method. Accordingly, the first projection (112) and third projection (121) formed on the bracket (100), and the second projection (310) formed on the upper cap (300), may also be formed simultaneously by injection molding when the bracket (100) and upper cap (300) are integrally formed.

Next, the lower cup (400), which is coupled to the bracket (100), is inserted from below the receiving hole (111) upward to support the lower surface of the bush (200). At this time, the lower cup (400) may be inserted from below the receiving hole (111) such that the lower end of the bracket (100) is seated on and supported by the step portion (420), and the insertion portion (410) is inserted into the lower side of the receiving hole (111).

Thereafter, the bracket (100) and the lower cup (400) may be joined by welding. At this time, the bracket (100) and the insertion portion (410) may be welded together, and a laser welding method using a laser may be applied.

As such, in the top mount (10) for a suspension according to an embodiment of the present invention, the top mount is made of plastic along with the upper cap (300), thereby achieving weight reduction compared to conventional ones made of metal. As a result, vehicle weight can be reduced, improving fuel efficiency. Also, although the bracket (100) and the upper cap (300) are made of plastic, which is relatively less durable, their shapes are improved by the first projection (112), second projection (310), and third projection (121), thereby maintaining, supplementing, or improving durability. In addition, since the bracket (100) and upper cap (300) are integrally formed and manufactured through injection molding, the number of parts and assembly processes can be reduced, improving productivity, and the assemblability can be improved by welding and coupling the bracket (100) and the lower cup (400). Through this, not only the vehicle economy but also marketability can be improved.

Although the present invention has been described with reference to limited embodiments and drawings, the invention is not limited thereto and various modifications and variations are possible within the scope of the technical idea of the invention and the scope of equivalents of the claims to be described below, by those of ordinary skill in the technical field to which the present invention belongs.

1. A top mount for vehicle suspension, comprising:
a bracket coupled to a vehicle body and having a receiving hole therein;
a bush disposed in the receiving hole;
an upper cap provided on the bracket to be seated on an upper side of the receiving hole and to support an upper surface of the bush; and
a lower cup inserted into a lower side of the receiving hole and coupled to the bracket to support a lower surface of the bush,
wherein the bracket and the upper cap are integrally formed of plastic.

2. The top mount for vehicle suspension of claim 1,
wherein the bracket and the upper cap are made of plastic comprising a mixture of nylon-based plastic and glass fiber-reinforced plastic.

3. The top mount for vehicle suspension of claim 1,
wherein the bracket comprises:
a main body portion having the receiving hole formed therein; and
flange portions obliquely extending from both sides of the main body portion.

4. The top mount for vehicle suspension of claim 3,
wherein the main body portion comprises a plurality of first protrusions being spaced apart from each other along an outer circumferemtial surface formed to protrude outward from the outer circumferential surface and extend in a vertical direction.

5. The top mount for vehicle suspension of claim 1,
wherein the upper cap comprises a plurality of second protrusions protruding upward from a top surface, extending radially from an opening formed at a center, and arranged spaced apart around the opening.

6. The top mount for vehicle suspension of claim 3,
wherein the flange portion comprises a plurality of third protrusions protruding downward from a bottom surface, extending in a longitudinal direction of the flange portion, and arranged spaced apart along an outer circumferential surface of the main body portion that contacts the flange portion.

7. The top mount for vehicle suspension of claim 4,
wherein the first protrusions extend from around the upper cap to a lower side of the main body portion, and portions where the main body portion and the flange portion meet are also extended to portions in contact with the flange portion.

8. The top mount for vehicle suspension of claim 1,
wherein the lower cup comprises:
an insertion portion having an outer circumferential surface inserted into the lower side of the receiving hole; and
a stepped portion protruding from a lower end of the insertion portion to support a lower end of the bracket.

9. The top mount for vehicle suspension of claim 1,
wherein the bush comprises:
an inner pipe fixed to an upper end of a piston rod and positioned at a center of the receiving hole;
an outer pipe press-fitted into the receiving hole of the bracket; and
a vibration-damping rubber interposed between the inner pipe and the outer pipe.

10. The top mount for vehicle suspension of claim 3,
wherein the flange portion includes a bolt coupling hole formed obliquely through the flange portion.

11. The top mount for vehicle suspension of claim 10,
further comprising a washer coupled to one side of the bolt coupling hole.

12. A method for manufacturing a top mount for vehicle suspension, comprising:
integrally forming, of plastic, a bracket coupled to a vehicle body and having a receiving hole therein, and an upper cap seated on an upper side of the receiving hold and provided on the bracket;
inserting a bush into a lower side of the receiving hole so that the bush is disposed inside the receiving hole;
inserting a lower cup from the lower side to the upper side of the receiving hole such that the lower cup supports a lower surface of the bush and is coupled to the bracket; and
welding the bracket and the lower cup to couple them together.

13. The method for manufacturing a top mount for vehicle suspension of claim 10,
wherein the lower cup comprises an insertion portion having an outer circumferential surface inserted into the lower side of the receiving hole and a stepped portion protruding from a lower end of the insertion portion to support a lower end of the bracket,
wherein the lower cup is inserted from the lower side to the upper side of the receiving hole such that the lower end of the bracket is seated and supported by the stepped portion, and
wherein the bracket and the insertion portion are welded and coupled together.

14. The method for manufacturing a top mount for vehicle suspension of claim 12,
wherein the bracket and the upper cap are injection-molded.
